(19) United States
(12) Patent Application Publication
(10) Pub. No.: US 2011/0237115 A1
(43) Pub. Date: Sep. 29, 2011

(54) EXTENSION SOCKET

(75) Inventor: XIANG CAO, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/787,522

(22) Filed: May 26, 2010

(30) Foreign Application Priority Data
Mar. 29, 2010 (CN) 201010134636.7

(51) Int. Cl. H01R 13/64

(52) U.S. Cl. 439/374

(57) ABSTRACT

An extension socket includes two positioning arms and at least two receiving portions. The positioning arms are opposite to each other. The receiving portions connect the positioning arms and are parallel to each other. Each of the receiving portions defines a groove. Each positioning arm defines a guide slot adjacent and oblique to each of the receiving portions. The guide slot communicates with the corresponding groove.

### BACKGROUND

1. Technical Field

The present disclosure relates generally to extension sockets and, more particularly, to an extension socket for a computer.

2. Description of Related Art

An electronic device such as a computer often has a plurality of extension sockets for receiving extension cards, to expand the performance of the computer. For example, a memory bank received in one extension socket expands memory of the computer.

A commonly used extension socket for receiving memory banks includes two positioning arms, a first receiving portion, and a second receiving portion. The first receiving portion and the second receiving portion are parallel and connect the positioning arms respectively. The first receiving portion defines a first groove, and the second receiving portion defines a second groove. Each positioning arm defines a first guide slot adjacent to the first receiving portion and parallel to the first receiving portion. The first guide slot communicates with the first groove. Each positioning arm defines a second guide slot adjacent to the second receiving portion and parallel to the second receiving portion. The second guide slot communicates with the second groove. In use, the memory banks are received in the first guide slot and the second guide slot respectively, until an end of the memory banks is received in the first groove and the second groove.

For improvement of performance of the computer, memory enhancement may be desired. However, the extension socket can receive only two memory banks, thus restricting memory improvement. Enlarging a size of the extension socket to add additional receiving portions, would increase a size of a motherboard on which the extension socket is assembled, and the overall size of the computer using the motherboard.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of an embodiment of an extension socket.

FIG. 2 is similar to FIG. 2, but viewed from another aspect.

FIG. 3 is an isometric view of the extension socket of FIG. 1 receiving memory banks.

### DETAILED DESCRIPTION

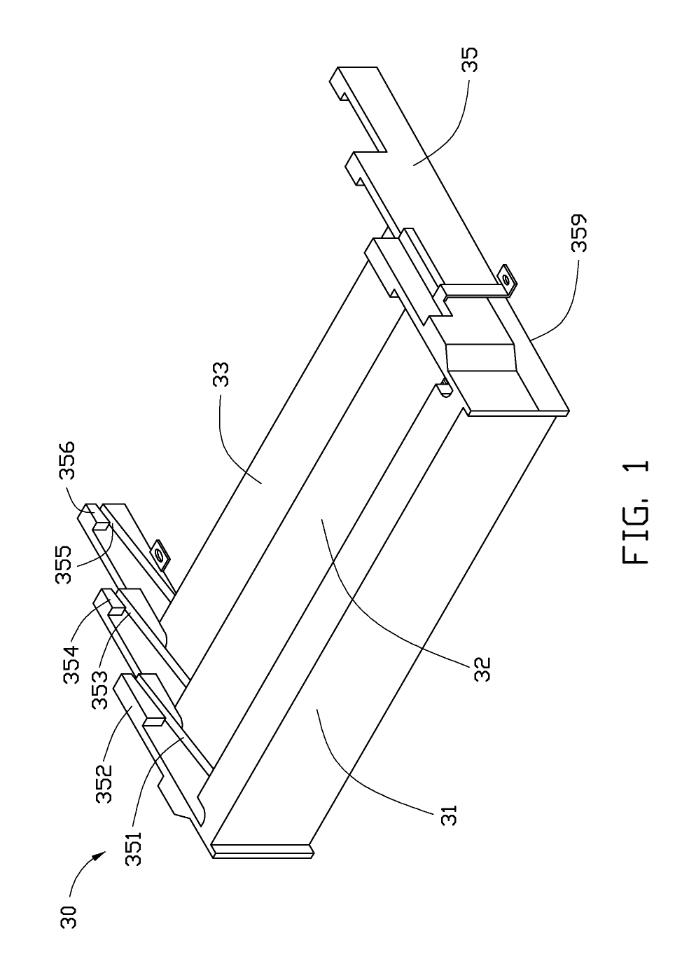

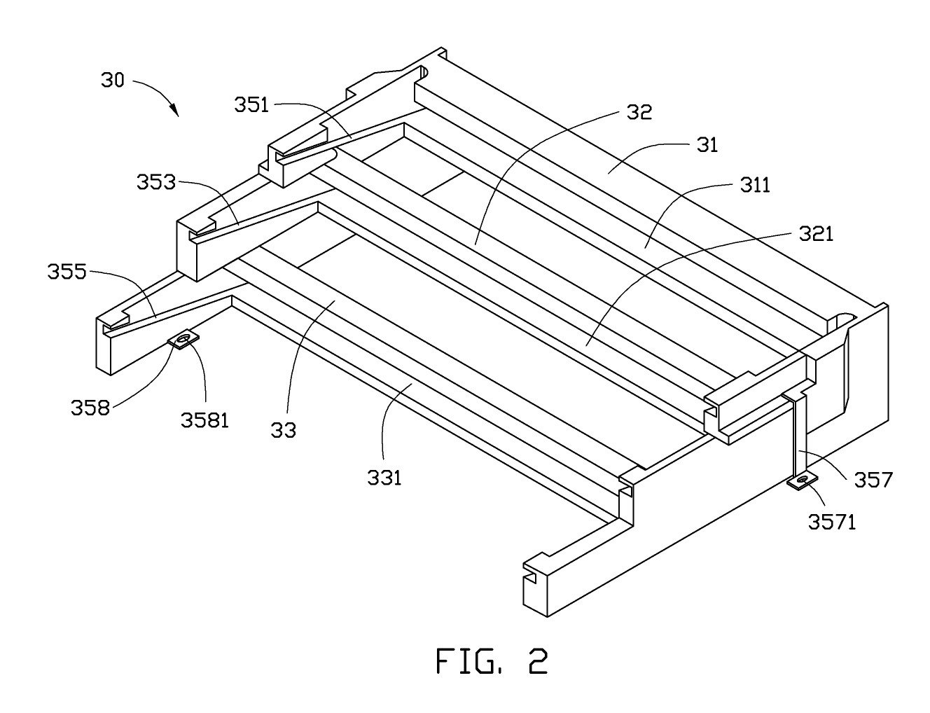

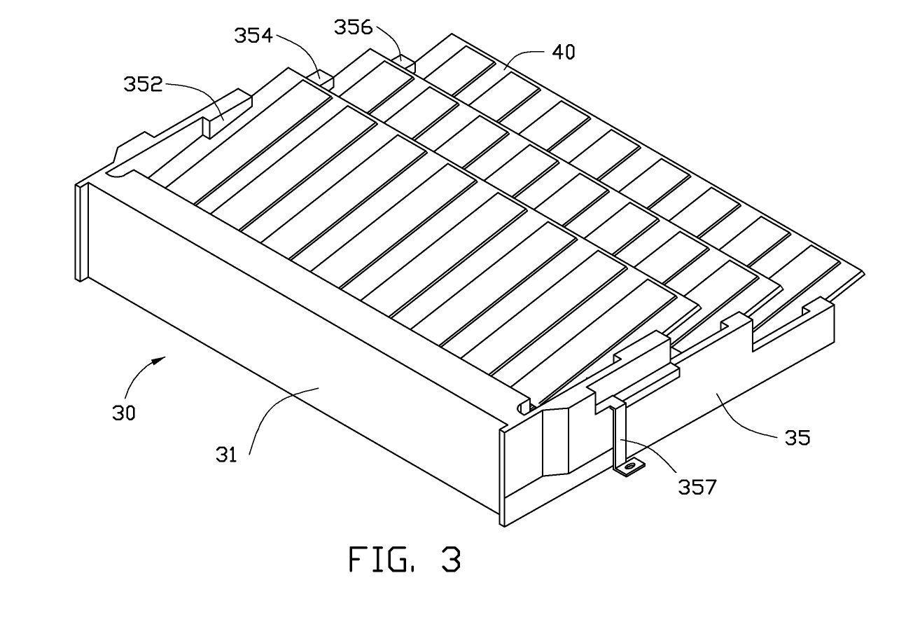

Referring to FIGS. 1 through 3, an embodiment of an extension socket 30 for receiving memory banks 40 includes two positioning arms 35 opposite to each other, a first receiving portion 31, a second receiving portion 32, and a third receiving portion 33. The first receiving portion 31, the second receiving portion 32, and the third receiving portion 33 connect the positioning arms 35 respectively, and are substantially parallel to each other. In the illustrated embodiment, the first receiving portion 31, the second receiving portion 32, and the third receiving portion 33 are evenly arranged between the two positioning arms 35, and a height of the first receiving portion 31, the second receiving portion 32, and the third receiving portion 33 relative to a bottom surface 359 of the positioning arm 35 gradually decreases.

The first receiving portion 31 defines a first groove 311. Each positioning arm 35 defines a first guide slot 351 adjacent to the first receiving portion 31. The first guide slot 351 communicates with the first groove 311. A first limiting protrusion 352 is formed on an end of the first guide slot 351 away from the first receiving portion 31.

The second receiving portion 32 defines a second groove 321. Each positioning arm 35 also defines a second guide slot 353 adjacent to the second receiving portion 32. The second guide slot 353 communicates with the second groove 321. A second limiting protrusion 354 is formed on an end of the second guide slot 353 away from the second receiving portion 32.

The third receiving portion 33 defines a third groove 331. Each positioning arm 35 defines a third guide slot 355 adjacent to the third receiving portion 33. The third guide slot 355 communicates with the third groove 331. A third limiting protrusion 356 is formed on an end of the third guide slot 355 away from the third receiving portion 33. In the illustrated embodiment, the first guide slot 351, the second guide slot 353, and the third guide slot 355 are substantially parallel to each other.

A first fixing portion 357 is formed on an outer surface of each positioning arm 35, and a second fixing portion 358 is formed on an inner surface of each positioning arm 35. The first fixing portion 357 and the second fixing portion 358 are configured for connecting the extension socket 30 to an electronic device (not shown). In the illustrated embodiment, the first fixing portion 357 is substantially L-shaped and defines a first fixing hole 3571, and the second fixing portion 358 is a rectangular piece and defines a second fixing hole 3581.

In use, three memory banks 40 are received in the first guide slot 351, the second guide slot 353, and the third guide slot 355 respectively, until an end of each memory bank 40 is received in the first groove 311, the second groove 321, and the third groove 331 (as shown in FIG. 5). Because the first guide slot 351, the second guide slot 353, and the third guide slot 355 are oblique to the first receiving portion 31, the second receiving portion 32, and the third receiving portion 33, the extension socket 30 can form more receiving portions of a predetermined size. Thus, the extension socket 30 can receive more memory banks 40, without the need to enlarge the extension socket 30.

It should be pointed out that the extension socket 30 can form more than three receiving portions, and define guide slots oblique to the receiving portions. The extension socket 30 can also form two receiving portions, and define guide slots oblique to the receiving portions, thus reducing a size of the extension socket 30. In addition, the angle of the guide slots relative to the receiving portions can be adjusted according to the number of the receiving portions.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An extension socket, comprising:
two positioning arms opposite to each other; and
at least two receiving portions connecting the positioning arms and substantially parallel to each other, each of the at least two receiving portions defining a groove therein;
wherein each positioning arm defines a guide slot adjacent and oblique to each of the at least two receiving portions, and each guide slot communicates with the corresponding groove.

2. The extension socket of claim 1, wherein the at least two receiving portions are evenly arranged between the two positioning arms.

3. The extension socket of claim 2, wherein a height of the at least two receiving portions relative to a bottom surface of the positioning arms gradually decreases.

4. The extension socket of claim 1, wherein each positioning arm further comprises a limiting protrusion formed on an end of each guide slot away from the receiving portion.

5. The extension socket of claim 1, wherein the at least two receiving portions are three receiving portions.

6. The extension socket of claim 5, wherein each positioning arm further comprises a first fixing portion formed on an outer surface of each positioning arm, and a second fixing portion formed on an inner surface of each positioning arm.

7. The extension socket of claim 5, wherein each first fixing portion is substantially L-shaped .

8. The extension socket of claim 5, wherein each second fixing portion is rectangular.

9. An extension socket, comprising:
two positioning arms opposite to each other; and
at least two receiving portions connecting the positioning arms and substantially parallel to each other;
wherein each positioning arm defines a guide slot adjacent and oblique to each of the at least two receiving portions, and the guide slots are substantially parallel to each other.

10. The extension socket of claim 1, wherein the at least two receiving portions are evenly arranged between the two positioning arms.

11. The extension socket of claim 2, wherein a height of the at least two receiving portions relative to a bottom surface of the positioning arms gradually decreases.

12. The extension socket of claim 1, wherein each positioning arm further comprises a limiting protrusion is formed on an end of each guide slot away from the receiving portion.

13. The extension socket of claim 1, wherein the at least two receiving portions are three receiving portions.

14. The extension socket of claim 5, wherein each positioning arm further comprises a first fixing portion is formed on an outer surface of each positioning arm, and a second fixing portion is formed on an inner surface of each positioning arm.

15. The extension socket of claim 14, wherein each first fixing portion is substantially L-shaped.

16. The extension socket of claim 14, wherein each second fixing portion is rectangular.
